(19) United States
(12) Patent Application Publication
(10) Pub. No.: US 2026/0100781 A1
(43) Pub. Date: Apr. 9, 2026

(54) LOW-POWER DATA TRANSFER

(71) Applicants: Tractian Technologies Inc, Atlanta, GA (US); Tractian Limited, São Paulo (BR)

(72) Inventors: Andrei Alves Cardoso, São Paulo (BR); João Pedro Vilas Boas Silva, São Paulo (BR); Igor Vinicius Alvarenga Marinelli, Atlanta, GA (US); Pedro Calori Badini, São Paulo (BR)

(21) Appl. No.: 19/354,597

(22) Filed: Oct. 9, 2025

Related U.S. Application Data
(60) Provisional application No. 63/705,447, filed on Oct. 9, 2024.

(51) Int. Cl. H04L 1/08

(52) U.S. Cl. CPC H04L 1/08

(57) ABSTRACT

A maintenance monitoring and recommendation infrastructure can include a plurality of monitors, which can be attached to various industrial equipment. The monitors can include a plurality of sensors and wireless and/or wired communication circuitry to transmit the sensor data to a receiver. The receiver can be connected to the maintenance monitoring infrastructure, where the sensor data can be used to perform maintenance data analysis and provide artificial-intelligence-based maintenance recommendations. In some embodiments, the monitors can be battery-powered. An efficient wireless communication method between monitors and receivers can include splitting a payload into packets, transmitting a plurality of packets, sequentially, waiting for receipt acknowledgement from the receiver and resending a missing packet, before sending a additional bursts.

### BACKGROUND

This application claims the benefit of priority to U.S. Provisional Application No. 63/705,447, filed on Oct. 9, 2024, which is hereby incorporated by reference in its entirety.

### BACKGROUND

### Field

This invention relates generally to the field of wireless communication and more particularly to low-power wireless data transfer between battery-powered devices and one or more base stations.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Industrial plants can include numerous mechanical machines with thousands of moving parts. To increase the efficiency of plant operations, the machines are monitored for maintenance purposes. Monitoring can include a trained technician visually inspecting the machines, observing the machine operations, and listening for any abnormal auditory cues that can indicate a present or potential maintenance-related fault in the machines. The technicians can also perform more sophisticated diagnosis, using maintenance and diagnostic tools. Continuous monitoring of industrial machines can present operational inefficiencies and cost to an industrial plant, particularly as the number of machines can be substantial in an industrial plant. For these and similar reasons, plants or busy shops with mechanical machines can benefit from an automated maintenance infrastructure. The automatic maintenance infrastructure can continuously collect maintenance-related data from various machines, detect maintenance-related events, and recommend appropriate action.

An automatic maintenance infrastructure can take advantage of monitors and receivers that are equipped with wireless communication technology. Since the monitors in some or many cases can be battery-powered, there is a need for a robust communication technology, which can reliably transmit data payloads between the monitors and receivers, while preserving the battery life of the monitors.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1A illustrates example diagrams of a monitor, industrial machines, and an infrastructure of fault monitoring and maintenance operations according to some embodiments.

FIG. 1B illustrates an exploded view of the monitor of the embodiment of FIG. 1A.

FIG. 2 illustrates a diagram of the various layers utilized for providing wireless communication between a monitor and a receiver.

FIG. 3 illustrates a diagram of data division, according to some embodiments.

FIG. 4 illustrates a flowchart of an example method of transmission, according to some embodiments.

FIG. 5 illustrates a flowchart of an example reception method according to some embodiments.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Industrial machines can benefit from consistent and accurate fault monitoring with artificial intelligence processing of the monitored data. In some embodiments, a plurality of small monitor assemblies, each equipped with wireless communication circuitry can be attached to various industrial machines in a plant. The monitors can sense and report various operational parameters related to fault monitoring. For example, temperature and vibration can be monitored and reported. The quality of vibrations, vibration trend data and other characteristics can be indicators of fault occurring or developing in an industrial machine. Similarly, temperature and temperature trends of a machine can include indicators of occurring or upcoming faults in the machine.

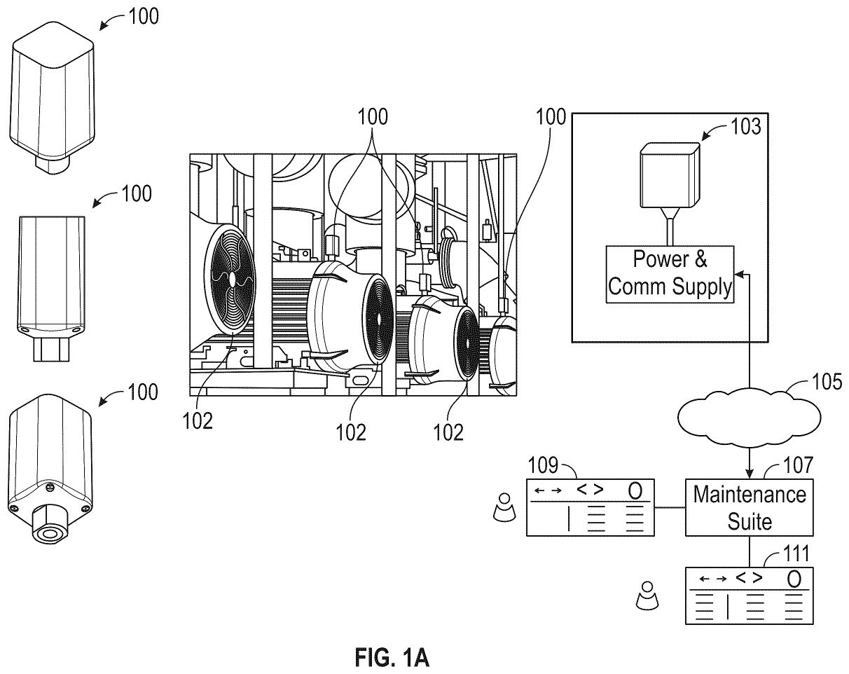

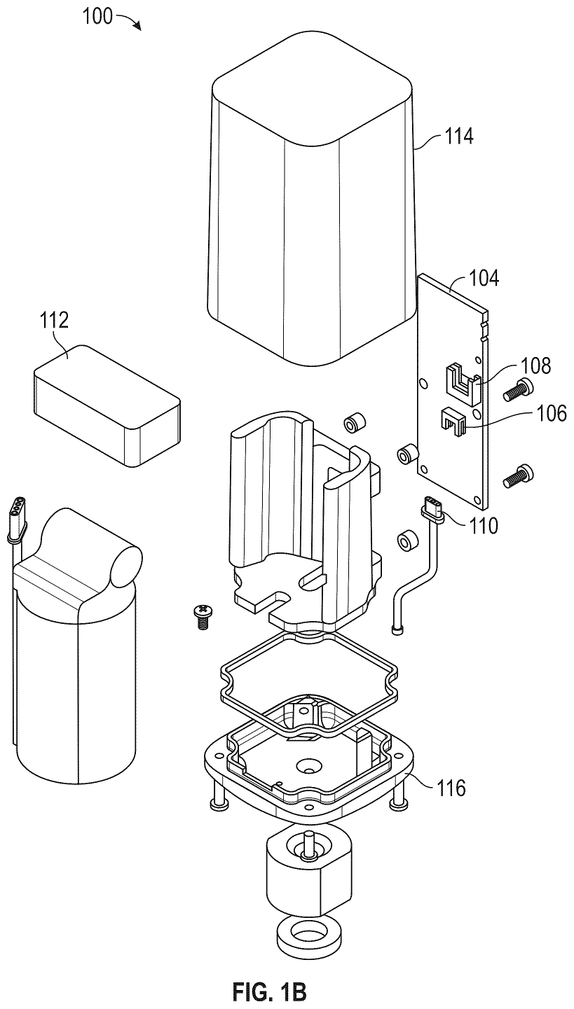

FIG. 1A illustrates example diagrams of a monitor 100, industrial machines 102, and an infrastructure of fault monitoring and maintenance operations according to some embodiments. The monitor 100 can be battery operated and can include a variety of sensing components enclosed in a housing. The monitor 100 can attach to machines 102 in the plant using a magnetic connection and/or by using other methods of attachment and fastening to secure the monitors 100 to machines 102 in the plant. The attachment of the monitors 100 to machines 102 can depend on the magnitude of the vibrations and other considerations related to the environment of the machines 102 and the plant. For example, if larger magnitude vibrations are expected, the connection between the monitors 100 and the machines 102 can be secured with an adhesive agent, so the monitors 100 can maintain their connections to the machines 102, despite large vibrations.

The monitors 100 can include wireless communication circuitry and can be in wireless communication with one or more receivers 103. In some embodiments, one or more monitors 100 can be modified to be in wired communication with a receiver 103 and have a connection to an outlet source of power. In other words, the source of power and type of communication of the monitors 100 can be modified, depending on the application and the environment of the plant to include any combination of battery-operated, outlet-operated, wired communication, and wireless communication. Similarly, the receivers 103 can include both wired and wireless communication circuitry. The receivers 103 can also be powered with or without the use of a battery. In some embodiments, both the monitors 100 and the receivers 103 can wirelessly communicate to a portable computer, such as a laptop, a smart phone, a smart tablet, or other portable devices, in the field, using a local or cellular wireless network. Although the term receiver is used, the receivers can also send data to monitors 100. Consequently, receivers 103 can be transceiver devices. For example, a receiver 103 can send a configuration file to a monitor 100 to enable, disable or otherwise configure various operating parameters of the monitor 100.

The numbers and locations of the receivers 103 can depend on the size of the plant and then numbers and distances of the monitors 100, relative to the receiver 103 and the wireless communication technology used to communicate between the monitors 100 and the receiver 103. The receivers 103 can be mounted at various locations in a plant and can have connection to a power and a communication source. For example, the receivers 103 in a plant can be in wired and/or wireless communication to one or more communication portals 105. Example communication portals 105 can include a local network, the Internet, one or more cloud infrastructures, gateways, other receivers 105, and other communication midpoints, or endpoints. The receivers 103 can transmit the fault monitoring data for upstream processing. The receivers 103 can also receive various operational configuration files, settings files, and/or other operating parameters and can transmit the operating parameters to the monitors 100. Examples operating parameters can include various timing and frequency of when and how the monitors 100 should collect data from the machines 102.

A maintenance suit 107 can receive monitoring data from the monitors 100 and perform processing related to fault monitoring and maintenance operations on the data. The maintenance suite 107 can include a variety of submodules and databases that can support processing of the monitoring data, including, storage of the data, generating reports from the data, extracting trends from the data, generating fault prediction from the data, generating maintenance action items, tickets, generating alerts, and/or other automated actions related to the maintenance of the machines 102. In some embodiments, the operations of the maintenance suite 107 can include artificial-intelligence submodules that can assist in fault prediction, maintenance recommendation pattern and trend detection, and other data analytics action, augmented or generated by artificial intelligence models. Example artificial intelligence techniques and/or models used by maintenance suite 107 can include neural networks, deep neural networks, machine learning, convolutional neural networks (CNNs), random forests, and others.

The maintenance suite 107 can support a variety of user interfaces (UIs). For example, the maintenance suite 107 can support a frontend user interface 109 and a backend user interface 111. Various parameters related to the operation of the monitors 100 can be viewed and/or modified via the user interfaces 109, 111. The user interfaces 109, 111 can provide access for a user to generate or modify configuration files, settings and operating parameters for the monitors 100 and the maintenance suite 107. The users can also view the output of the maintenance suite 107 via the user interfaces 109, 111.

While not shown, the monitors 100 are not the only maintenance-related in-field components operated by the maintenance suite 107. Other components associated with monitoring and maintenance of the machines 102 and the plant can also be in communication with the maintenance suite 107. For example, in some embodiments, energy management components in communication with the maintenance suite 107, can monitor the power consumption of the machines 102 and their plant.

Depending on the size of an industrial plant, the monitors 100 can be numerous, for example in the hundreds or thousands. The maintenance suite 107 can streamline and track data from hundreds or thousands of machines and automate the identification and tracking of maintenance-related tasks for a large industrial plant, having hundreds or thousands of machines.

FIG. 1B illustrates an exploded view of a monitor 100. Some example components include the printed circuit board (PCB) 104, the microcontroller 106, an accelerometer 108, a temperature sensor 110, a battery module 112, various spacers, holders, internal conduits, and a housing 114. The housing 114 can house the internal components of the monitor 100. A housing lid 116 can enclose the housing 114 and seal the internal components of the monitor 100 from the outside. The monitor 100 can be made water-, dust- and particle-resistant by a variety of techniques. For example, in some implementations, the monitor 100 can be resin-coated. The battery module 112 can include one or more lithium-ion batteries, and a battery management system (BMS). In other embodiments, the BMS can be external to the battery module 112, for example, it can be mounted on the PCB 104. In some embodiments, the life expectancy of the battery module 112 can be between three to five years.

The monitor 100 can include communication circuitry, corresponding to the communication circuitry of one or more receivers, for example, the receivers 103, and one or more local, private and/or public communication network, including one or more cellular networks. The choice of network and communication circuitry can depend on the size of the plant and the distance of the monitor 100 from a receiver 103. The communication circuitry of the monitor 100 can be mounted on the PCB 104. In some embodiments, the communication circuitry may be integrated in the microcontroller 106. Similarly, in other embodiments, various components can be combined into one or use a component that integrates several components together. The monitor 100 can include a magnetic collar to provide magnetic attachment between the monitor 100 and the machine 102. In some embodiments, the temperature sensor 110 can be routed to a surface very near the point of contact between the monitor 100 and the machine 102 to provide a more accurate reading of the temperature of the machine 102.

The accelerometer 108 can be a micro-electro-mechanical system (MEMS) accelerometer, capable of one, two, or three axis acceleration data. For example, in some embodiments, the accelerometer 108 can measure forces in three directions along the XYZ axes. The accelerometer 108 can measure and transmit both magnitude and spectral data of the vibrations of a machine 102 to the microcontroller 106.

The microcontroller 106 can be a collection of various components, including computer or computing components. Example components of the microcontroller 106 can include a processor, such as a central processing unit (CPU), permanent and impermanent memory, including for example, random access memory (RAM) of various kinds, solid state, flash or other permanent memory, interconnects, buses and communication vias between the various components. In some embodiments, the microcontroller 106 can include external communication circuitry to enable wireless communication, including radio frequency identification (RFID), Bluetooth, cellular, or other communication technologies. In other embodiments the monitor 100 can include dedicated wireless communication circuitry, fabricated or included in the monitor 100, in a separate component than the microcontroller 106.

The monitors 100 can be configured to spend the majority of their time in hibernation state to conserve battery power. In hibernation mode, the power to all or some of the components of the monitor 100 can be reduced or minimized, thereby reducing the overall battery consumption in the hibernation state. The monitors 100 can be configured to periodically exit hibernation mode and enter normal operation mode, where power and functionality to some or all components is restored. For example, the monitors 100 can perform periodic sampling of various operational parameters of the machines 102, such as temperature and vibrations. When scheduled sampling is not performed, the monitors 100 can be in hibernation mode.

The monitors 100 can perform a variety of samplings of machine operation parameters. For example, for the vibration parameter of the machines 102, the monitors 100 can perform various samplings at different intervals and with different characteristics. Example sampling characteristics can include sampling intervals, sampling frequency, sampling rate, sampling range, sampling resolution and other characteristics. Sampling interval can refer to the period by which the monitor 100 turns ON and performs a sampling with a selected set of sampling characteristics. In some embodiments, the monitors 100 can be configured to perform scheduled sampling sessions, which are samplings performed at selected intervals. The selected intervals can depend on the type of machines 102 and other factors that are application-dependent, based on where the monitors 100 are used. Example sampling intervals can include sampling with intervals separated by minutes, hour or hours, days, or even months, and other intervals.

The monitor 100 is a battery-operated device. In most applications extending the longevity of the monitor 100 is proportional to the longevity of the battery module 112. A significant portion of the battery consumption of the monitor 100 relates to the transmission of data to the receiver 103. At the same time, typical industrial environment of the monitor 100 and the receiver 103 can present challenges for wireless transmission of data between the two devices. For example, industrial environments can introduce substantial noise and interference to wireless transmission of data between the two devices. Various wireless communication frameworks exist and can be utilized for transfer of data. A wireless communication framework can provide a basic level of functionality between transmission nodes. Referencing the open systems interconnection (OSI) model, various existing wireless communication frameworks can provide some of the functionality for wireless transmission of data between a monitor and a receiver. For example, an existing wireless communication framework can provide a physical layer for wireless transmission of data between the monitor and the receiver, using radio waves.

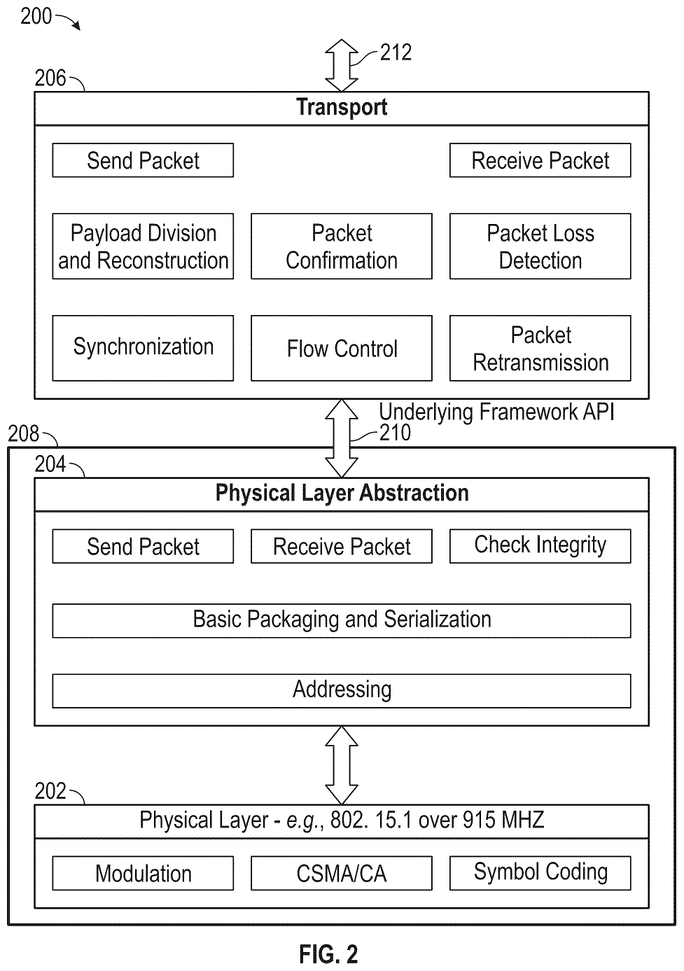

FIG. 2 illustrates a diagram 200 of the various layers utilized for providing wireless communication between a monitor and a receiver. The physical layer 202, and the physical layer abstraction 204 can be provided by an existing wireless communication framework. The described embodiments include a transport 206, which provides for an efficient wireless communication protocol between two or more communication endpoints or nodes. Although, the OSI model also utilizes the term “transport,” in the context of the present application, the term “transport” refers to a wireless communication method using the described embodiments. Consequently, the use of the term “transport” should not be taken to refer to the transport layer of the OSI model, or other usages of the term in the field of wireless communication technology. Transport 206 includes a collection of software modules and methods that implement efficient wireless communication between a monitor and a receiver, or a plurality of monitors and a plurality of receivers. The transport 206 can be implemented in hardware, using the processing power, wireless communication circuitry and/or other components of the monitor 100 and the receiver 103.

The physical layer 202 can manage various tasks related to the physical transmission of data. Such tasks can include modulation, performing carrier-sense multiple access with collision avoidance (CSMA/CA), symbol coding and others. The physical layer abstraction 204 can perform functions such as addressing, basic packaging and serialization, sending packets, receiving packets, checking the integrity of the transmission of the packets and other basic functions related to physical transmission of data. An existing wireless communication framework providing basic physical communication layers can be referred to as the underlying framework 208. The underlying framework 208 provides basic communication functionality to the transport 206 via an underlying framework application programming interface (API) 210. The transport 206 can reformat the data before delivering it to the underlying framework API 210 to match the requirements of the underlying framework 208.

The underlying framework 208 can establish one or more wireless communication channels between a sensor 100 and a receiver 103. The receiver 103 can transmit its identity and its resources via the underlying framework 208 to the transport 206. The monitor 100 can transmit data of varying size. Some data can be as small as a few bytes (e.g., 10 bytes) to keep the connection alive. Some data can be large in size. For example, an entire sampling data of a sampling session can be 200 kB. Larger size data typically cannot reliably be transmitted in a single burst. For example, the underlying framework 208 can support a maximum packet size (MPS) which it can reliably transmit. As a result, transport 206 includes functionality to split a payload into smaller size packets.

The transport 206 can be implemented in one or both of the monitors 100 and the receivers 103. Some of the functionality provided by transport 206 can include sending payloads, receiving payloads, sending packets, receiving packets, payload division and reconstruction, packet confirmation, packet loss detection, synchronization, flow control and others. Various existing communication protocols can be unsuitable for implementing a wireless communication protocol and framework between the monitor 100 and the receiver 103. To increase the longevity of the monitors 100, they have to operate under rigorous battery-saving constraints. At the same time, the industrial environment of the monitors 100 and the receivers 103 can introduce noise and interference, requiring a somewhat robust wireless communication framework to overcome the environmental challenges. Having to perform wireless transmission under rigorous battery-saving constraints, can render several existing wireless communication protocols unsuitable. For example, user datagram protocol (UDP) can be too unreliable for implementing transmission in the industrial environment of the monitors 100 and receivers 103. Transmission using transmission control protocol (TCP), on the other hand, while reliable and robust is too power-hungry. In some experiments, for example, using TCP for transmitting data between the monitors 100 and the receivers 103 drained the battery module 112 in one month, while the target life expectancy of a monitor 100 was three to five years. Consequently, the transport 206 implements a robust and reliable wireless communication protocol and framework, while adhering to the battery and power consumption constraints of the monitors 100. Transport 206 can provide API 212 to various hardware and/or software components of the monitor 100 to allow the monitor 100 to request transmission of data.

As part of its functionality, the monitor 100 can transmit data of various sizes. Payloads can include a larger or largest portion of the data the monitor 100 selects to transmit to the receiver 103. An example of a payload can be vibration samples collected over a sampling session. Typically, the underlying framework 208 can only transmit data reliably if the data is no larger than a maximum packet size (MPS). For example, for some underlying frameworks 208, the MPS can be 102 bytes, while an example size of a payload related to a sampling session can be 200 kB. The transport 206 can split the payload into packets of sizes less than or equal to MPS.

### Payload Identifier

The monitor 100 can transmit various payloads, simultaneously, or as the data in the payloads becomes available. In other words, the monitor 100 may transmit a first portion of a first payload, then transmit a first portion of a second payload, then transmit a second portion of a second payload, then transmit a first portion of a third payload and so forth, depending on the various sampling and data collection schedules configured in the monitor 100. At the same time, a receiver 103 can receive transmissions from multiple monitors 100. Payloads can be split into packets, and the packets can be transmitted in bursts of packets. In some embodiments, the data associated with a payload can include a payload identifier. The payload identifier can be used to identify and assemble the payload at a receiver (or a at a monitor) or at an upstream processing module. In other words, the payload identifier can be used to track all data associated with or related to a payload. When the payload is split in packets, each packet can include metadata, which can list the payload identifier of the packet.

### Data Splitting for Transport 206

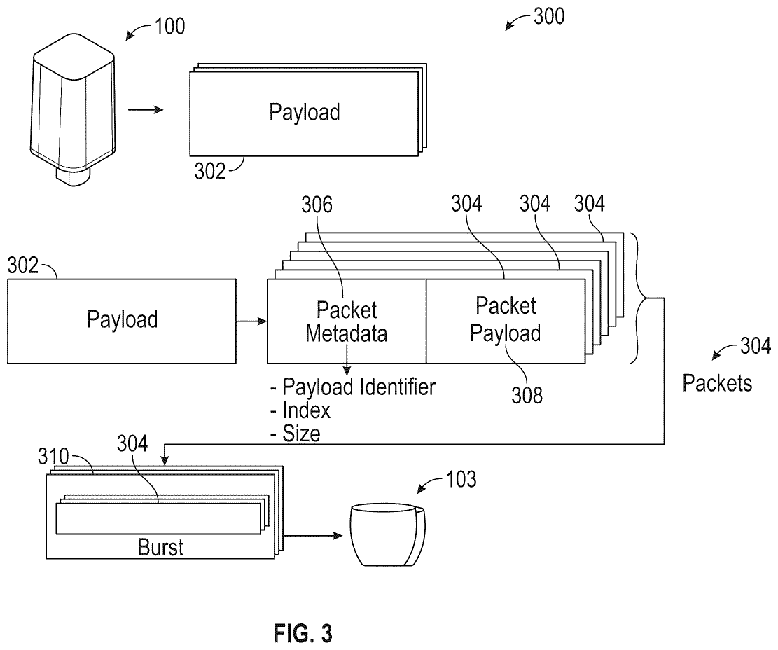

FIG. 3 illustrates a diagram 300 of data division, according to some embodiments. The monitor 100 generates payloads 302. The payloads 302 can be various sensor and monitoring data, collected during one or more sessions. For example, the monitor 100 can be configured to collect vibration, or temperature samples according to one or more schedules. Furthermore, the sampling sessions can have different characteristics, such as resolution, range, duration, frequency, etc. The transport 206 can split a payload 302 into a plurality of packets 304. Each packet 304 can include packet metadata 306 and packet payload 308. The packet metadata can include a variety of information, including for example the payload identifier to associate the packet 304 to its corresponding payload 302. The packet metadata can differ between the different packets 304. For example, a beginning or an end packet 304 can include packet metadata indicating that the packet is a first or last packet in a series of packets. Packet metadata can include an index number, indicating the sequential order of a packet 304 in the plurality of the packets 304. Another example metadata 306 is the size information, so the beginning and end location of an individual packet 304 in a payload 302 can be determined. Other metadata can also be included. Packets 304 can be sent to the receiver 103 in one or more bursts 310. A burst is a collection of packets 304. The number of packets in a burst can be variable or fixed, depending on a variety of factors, such as the capabilities or specifications of the underlying framework 208, availability of data for transmission and other factors.

### Method of Transmission of Transport 206

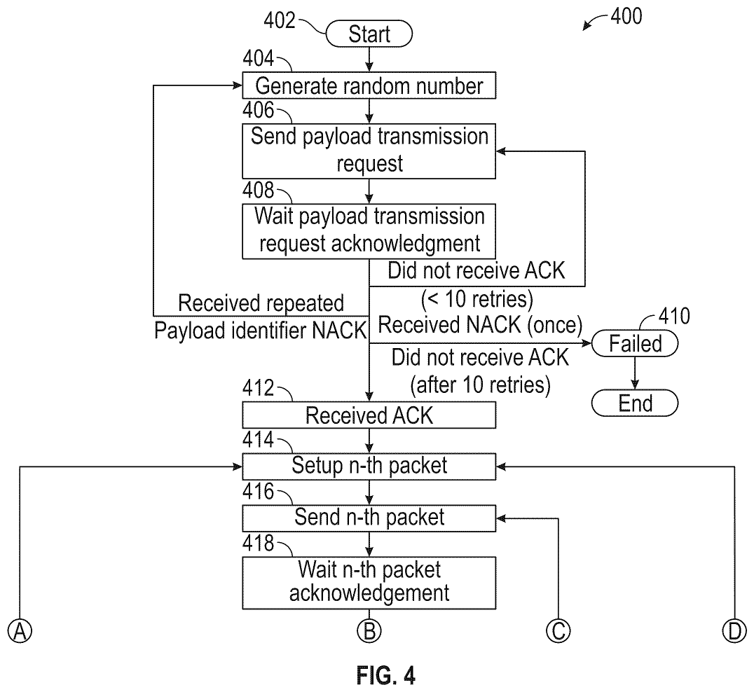

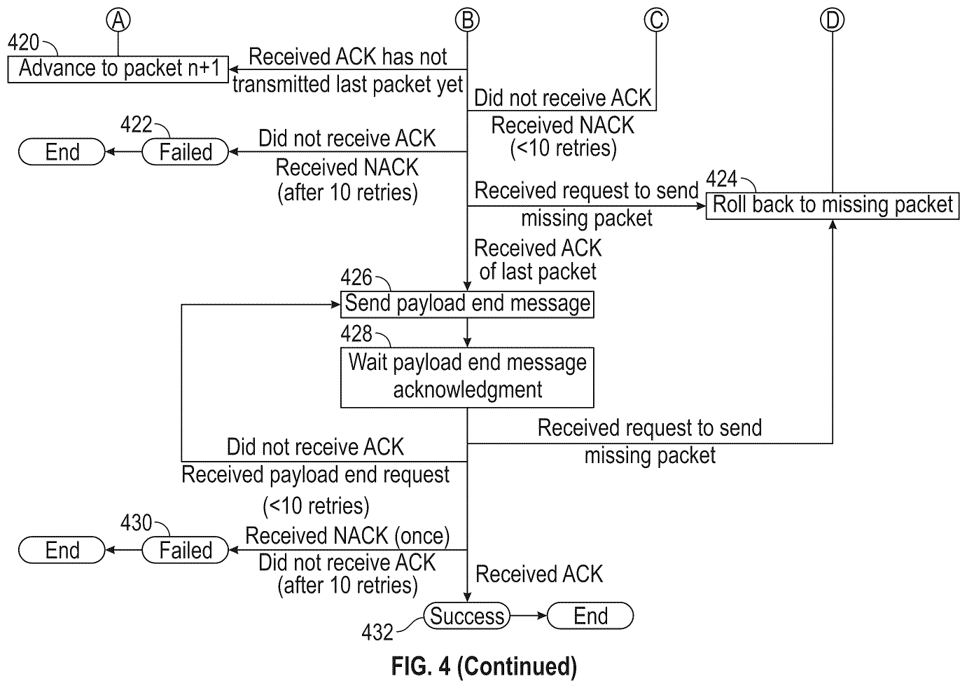

FIG. 4 illustrates a flowchart 400 of an example method of transmission of the transport 206, according to some embodiments. The method starts at step 402. At step 404, a random number is generated. The random number can serve as a payload identifier. At step 406, the monitor 100 can send a payload transmission request to the receiver 103. The request is accompanied by the payload identifier generated at step 404. At step 408, the monitor 100 can wait for a payload transmission request acknowledgement (ACK) from the receiver 103. If the payload transmission request acknowledgement has not been received in less than a threshold (e.g., “10”) number of tries, the request is resent. If after the threshold number of tries, the receiver 103 still hasn't sent an acknowledgement, the transmission ends at step 410 with a failure status. If the receiver 103 sends a “repeated payload identifier” negative acknowledgement (NACK) message, the method reverts to step 404, where another random payload identifier is generated.

At step 412 a positive acknowledge message from the receiver 103 is received, indicating the receiver's readiness to receive the transmission of the payload. The acknowledgement message at step 412 can also include some specification about the resources of the receiver. At step 414, a packet is set up for transmission. Setting up a packet can include determining the size of a packet, relative to the overall size of the workload and the transmission capabilities of the underlying framework 208. The size of a packet can be fixed or dynamically determined, as the size of the data to be transmitted changes. At step 416, the packet set up at step 414 is sent to the receiver 103. Step 418 includes waiting for an acknowledgement of receipt of the packet, sent at step 416, from the receiver 103. In some embodiments, sending one packet at a time and waiting for acknowledgement for a packet can be inefficient. In these embodiments, steps 414, 416 can include setting up and sending a burst of packets, where a burst can include multiple packets, and step 418 can include waiting for the receiver 103 to send multiple acknowledgements for each packet in a previous burst. Next, if the acknowledgement at step 418 is received, but the last packet has not yet been transmitted, the method moves to step 420, where the next packet or burst is set up by incrementing a counter, corresponding to the index of the next packets or burst of packets, and steps 414, 416 and 418 are repeated for the next packet or packets.

If an acknowledgement, from the receiver 103, for a packet or series of packets has not been received and the number of times the packet or packets have been sent is less than a threshold (e.g., “10”) number of tries, the method moves to step 416 and the packet or packets are resent. If after the threshold number of tries, an acknowledgement from the receiver 103 is not received, or a negative acknowledgement is received, the method fails at step 422.

The receiver 103 can monitor the status of incoming packets by inspecting the packet metadata 306, relative to the metadata of previous packets. For example, by monitoring the index of each incoming packet, the receiver 103 can determine a missing packet. For example, a packet, having an index two more than an immediately preceding packet can indicate a missing prior packet. For example, if first, second, and third packets are received, if the receiver next only receives packet fifth, the receiver can detect that the fourth packet is not sent or has been otherwise lost in transmission. Upon detecting a missing packet, the receiver 103 can send a request for the missing packet to the monitor 100. For example, the receiver can send a request for the index of the missing packet to the monitor. At step 424, if the monitor has received a request for a missing packet, the index of the next packet to be transmitted can be rolled back to the index of the missing packet, and the method can revert back to step 414, where the missing packet is set up again and sent through steps 416, 418.

At step 426 if an acknowledgement of reception of the last packet is received from the receiver 103, a “payload end” message is sent to the receiver 103. Step 428 includes waiting a selected period of time for an acknowledgement of the “payload end” message from the receiver 103. If the receiver sends another missing packet request, the method moves to step 424 and the steps for resending a missing packet are repeated. If the “payload end” acknowledgement is not received and the “payload end” message has not been transmitted more than a threshold number of tries (e.g., “10” tries), the method moves back to step 426, where the “payload end” message is resent. If after the threshold number of tries the acknowledgement of receipt of “payload end” message is not received, or a negative acknowledgement is received, the method ends with a failed status at step 430. Otherwise, if an acknowledgment of the “payload end” message is received, the method ends with a “success” status at step 432.

### Method of Reception of Transport 206

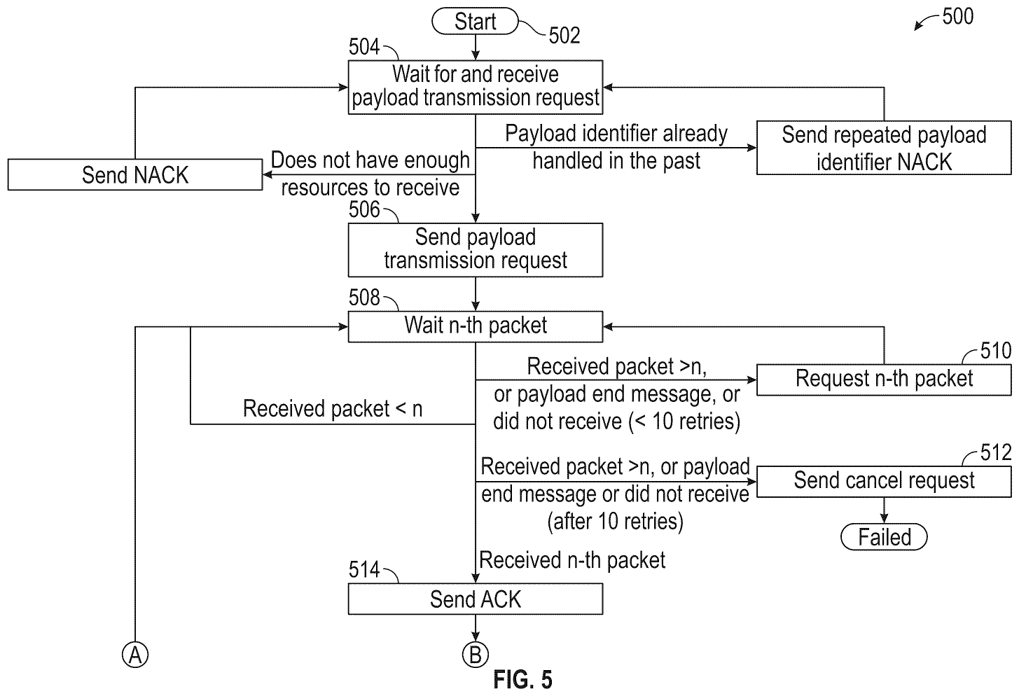

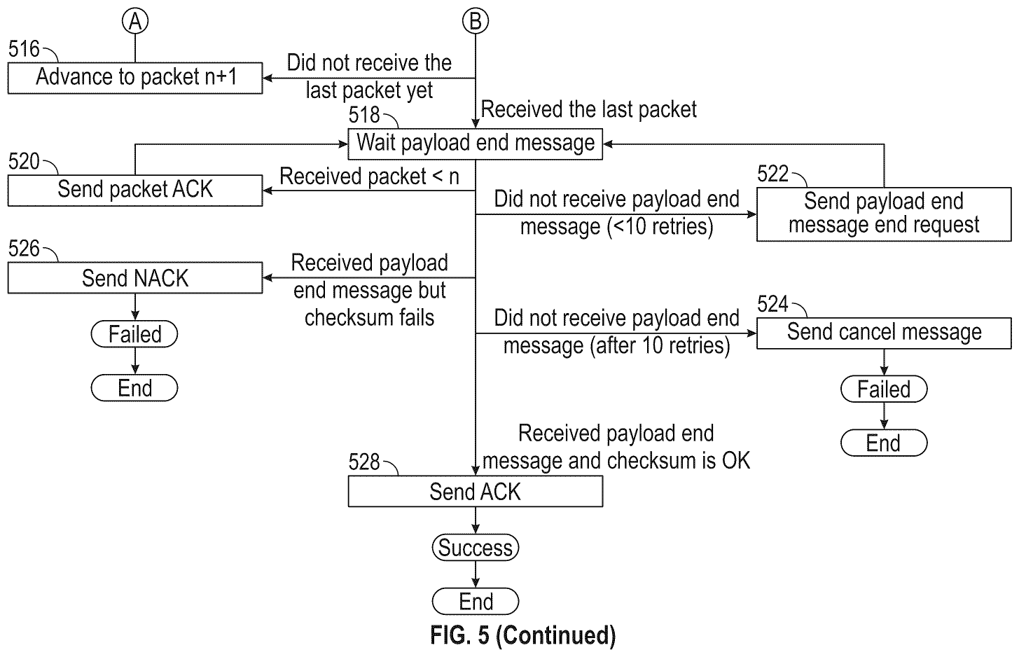

FIG. 5 illustrates a flowchart of an example reception method 500 according to some embodiments. The method starts at step 502. The receiver 103 can perform the method 500 when one or more communication channels between the receiver 103 and the monitor 100 have been established. As part of establishing the communication channels, the monitor 100 can inform the receiver 103 of an upcoming transmission and the characteristics of the transmission, such as number of packets, burst size, packet sizes, and other characteristics. monitor At step 504, the receiver 103 can wait for and receive a payload transmission request from the monitor 100. If the payload identifier has already been handled in the past, the receiver 103 sends a repeated payload identifier negative acknowledgement message. Similarly, if the receiver 103 does not have enough resources to hand a transmission, it can send a negative acknowledgment message. An example of not having enough resources can include not having enough available memory to receive a transmission. Otherwise, at step 506, the receiver 103 can send an acknowledgement of the reception of the payload transmission request. At step 508, the receiver 103 waits for an n-th packet, where the payload is split into packets having indexes ranging from “0” to “n”. In some embodiments, the waiting period at step 508 is 100 ms.

If the monitor sends a part with an index larger than an expected index or the receiver receives a payload END message, and there have been less than a threshold (e.g., 10 retries) to receive a packet, the packet is refused and the method continues to step 510. If there have been equal or more than a threshold number of retries (e.g., 10 tries) to receive packet, the method continues to step 512, where a cancel request is sent. After sending a cancel request, the receiver can perform the method 500 from step 502 again. If the monitor sends a packet with an index smaller than the expected index (a delayed packet), the packet is acknowledged but ignored, and the method reverts to step 508. If the monitor sends the correct n-th packet, the packet is received and the method continues to step 514, where the receiver sends an acknowledgment of the n-th packet to the monitor.

At step 510, if the receiver identifies that an n-th packet is missing, the receiver can send a request for the n-th packet to the monitor. The method then reverts to step 508. At step 514, the receiver can send acknowledgement message to the monitor indicating the reception of the n-th packet and its content. The receiver can process the content of each packet to evaluate a checksum for the packet and/or the payload. If the receiver expects to receive more packets, the method continues to step 516, where the index of the packet is incremented, and method reverts to step 508. If the receiver does not expect more packets, the method continues to step 518, where the receiver awaits a payload end message.

The payload end message can include a checksum for the payload, from the monitor, which the receiver can compare against a checksum calculated locally at the receiver. If the checksums do not match, the transmission has failed. Furthermore, if the monitor sends a delayed packet, the method can move to step 520, where the receiver can send an acknowledgment of the packet, if the index of the packet is less than “n”. After step 520, the method can move to step 518, where the receiver can send a request for a payload end message, to the monitor, and the monitor can continue with transmission. If the receiver does not receive a payload end message, but has tried less than a threshold number of tries (e.g., 10 times) to receive it, the method continues to step 522, where a “send payload end message” request is sent to the monitor.

If the receiver has not received a payload end message after a threshold number of tires (e.g., 10 retries), the method continues to step 524, where the receiver sends a cancelation message to the monitor. If the receiver receives a payload end message, but the checksum mismatches the calculated checksum of the received data, the method continues to step 526, where the receiver sends a negative acknowledgement message to the monitor, indicating the failed or mismatched checksums. If the monitor sends a payload end message with a valid checksum, the method goes to step 528, where the method ends with a success message.

In some embodiments, the transport 206 can implement the following features. if a PACKET CANCEL request is received at any time, the whole procedure is aborted and considered failed. If the monitor tries to send a packet while no reception is ongoing, the receiver can respond with a PACKET CANCEL message. If the monitor tries to send a payload end message of a previous transmission, the receiver can send a NACK if the previous transmission has failed. If the previous transmission has succeeded, the receiver can respond with an acknowledgement message. If the monitor tries to send a payload end message for an unknown transmission, the receiver can respond with a PACKET CANCEL message.

While the embodiments of transmission and reception of the transport 206 have been described for the scenario where the monitor 100 is the sender of a transmission and the receiver 103 is receiver of the transmission, the embodiments of transport 206 can be applied to the scenario where the receiver 103 is the sender of the transmission and the monitor 100 is the receiver of the transmission. An example of this scenario is when the receiver 103 is sending a monitoring and/or sampling configuration file to the monitor 100 to configure the monitor 100 with sampling schedules, and sampling characteristics, for example, when to conduct a sampling session, sampling resolution, sampling range, type, frequency and duration of sampling and/or other characteristics.

### Additional Features

In many applications of implementing a maintenance monitoring suite using the described embodiments, multiple monitors 100 and receivers 103 can be deployed. In some scenarios multiple monitors 100 can communicate with a receiver 103. There can be a scenario, where two or more monitors attempt to transmit packets to a receiver 103, almost simultaneously, causing the transmission of one or more monitors to fail. To remove or reduce the chance of simultaneous or near-simultaneous transmission, a delay in transmission can be introduced, where the monitor 100 awaits a first period (e.g., 100 ms) for receiving an acknowledgement from the receiver (e.g., step 408 in FIG. 4), and then the monitor 100 awaits a second period comprising a second delay in transmission period (e.g., 10 ms or another random number) before attempting to resend a packet. In these scenarios, the monitor awaits the sum of the first and the second periods (e.g., 110 ms) before attempting to resend a packet. This can reduce a monitor consistently failing due to parallel transmission with another monitor.

As described earlier to improve the efficiency of the methods 400, 500, multiple packets can be sent and received in a burst. This can also help the underlying framework 210 to perform its function more efficiently. Furthermore, the size of each packet can be dynamically determined, based at least in part on the capabilities of the underlying framework 210 and/or the size of a payload.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A method of communication between a monitor and a receiver, comprising:
receiving a payload;
determining a packet size, based at least in part on an underlying communication framework;
dividing the payload into a plurality of packets;
sending a payload transmission request to the monitor;
sending a burst of packets to the receiver, the burst comprising a plurality of the packets;
awaiting a first period of time for an acknowledgement of receipt of the burst from the receiver;
when no acknowledgement is received, awaiting a second period of time, before resending one or more packets to the receiver;
the receiver determining a missing packet, based at least in part on a sequential index of each received packet;
transmitting a missing packet index number to the monitor; and
the monitor, sending the missing packet to the receiver.

2. The method of claim 1 further comprising:
the monitor transmitting a payload end message to the receiver;
awaiting an acknowledgement receipt of the payload end message;
when an acknowledgement is not received, the monitor resending the payload end message if previous attempts of sending the payload end message does not exceed a selected threshold; and
when an acknowledgement is not received, the monitor canceling the transmission with a failure message if the resending of the payload end message in the previous attempts of sending the payload end message equals or exceeds a selected threshold.

3. The method of claim 1, further comprising:
generating a random number;
assigning the random number to the payload as the payload identifier;
transmitting the payload identifier along with each packet of a payload;
the receiver, checking the payload identifier against prior received payload identifiers; and
the receiver, issuing a repeated payload identifier message is the payload identifier has previously been used for another payload.

4. The method of claim 1, further comprising:
the receiver, sending a payload transmission request acknowledgement to the monitor;
the receiver, waiting for a packet;
the receiver receiving a packet and sending an acknowledgement of the packet to the monitor;
the receiver, sending a request for a missing packet to the monitor;
the receiver, waiting a first period of time before resending the request for the missing packet;
the receiver, resending the request up to a selected threshold;
the receiver, receiving a packet; and
the receiver, issuing an acknowledgement message to the monitor;
the monitor sending a payload end message;
the monitor sending a payload end message acknowledgment to the monitor;
the receiver, waiting a period of time for the payload end message and resending a payload end message request for a number of tries less than a threshold; and
when the receiver does not receive the payload end message after the threshold number of tries, the receiver issuing a failure message.

5. The method of claim 1, wherein the underlying framework comprises the physical layer and the physical layer abstraction of an open system interconnection (OSI) model.

6. The method of claim 1, wherein each packet comprises metadata, and the metadata comprises the size of each packet, and the method further comprises:
the monitor, generating a monitor checksum for a plurality of packets;
the receiver, generating a receiver checksum for the plurality of the packets;
the receiver, matching the checksums; and
generating a success or failure message, based at least in part on whether checksums match.

7. The method of claim 1, wherein each packet comprises metadata, wherein the metadata comprises one or more of the size of a packet, a sequential index of the packet, a burst checksum, and a payload checksum.
